(19) United States
(12) Patent Application Publication
(10) Pub. No.: US 2019/0175313 A1
(43) Pub. Date: Jun. 13, 2019

(54) PROCEDURE FOR PREPARATION DIGITAL DENTAL MAP

(71) Applicant: Árpád NAGY, Paks (HU)

(72) Inventor: Árpád NAGY, Paks (HU)

(21) Appl. No.: 16/322,405

(22) PCT Filed: Sep. 7, 2016
(86) PCT No.: PCT/HU2016/000060

§ 371 Date: Jan. 31, 2019

(30) Foreign Application Priority Data
Aug. 1, 2016 (HU) P 1600476

(51) Int. Cl. A61C 9/00; A61C 13/34; A61C 7/00

(52) U.S. Cl. CPC A61C 9/004; A61C 7/002; A61C 13/34

(57) ABSTRACT

In a method for preparing a digital dental map, a three dimensional digital model is prepared about the human teeth and dentures, a later plaster model made based on a later taken impression can be compared with the earlier sample, so that very minute objective changes become visible. If teeth later wear out, or a tooth is damages, it can be easily restored to the condition existing in the earlier time of registration. Additionally, a three dimensional printable real model can be produced from the data even later, that is the qualitative characteristics of the stored model do not change with the time elapsed. The procedure provides the possibility of the preparation of a more thorough design both in the field of prosthetics, implantology and orthodoncy, and the original face profile can be preserved for a life, and the data storage is independent from the dentist providing the treatment.

The patent represent such a procedure with the help of which it is possible to prepare the digital, 3D model of the human teeth, then later with the help of it the condition existing at taking the sample can be restored by the dental interventions.

Looking at the service list of a dental clinic of our days, we can find expressions like sealing of fissures, inlay, onlay, inlay bridge, veneer. In the 21^{st} century the soundness of teeth, prevention of dental caries can be ensured with almost 100 per sent efficiency by a treatment involving a minimal procedure. Denture is possible without grinding another tooth, or without tooth implantation, as well. There is also such a procedure, with the help of which the creation of new teeth is possible maintaining the own teeth. Thanks to the modern oral hygienic tools and dental treatments, people of our days have a significant possibility to preserve their permanent teeth in a healthy condition till the end of life. By a modern dental procedure, by the closing of fissures the caries of the fissures can be almost completely prevented. It is worth to make the closing of fissures after changing the milk teeth, ideally within half a year from the appearance of the permanent teeth primarily referring to the big molar tooth, and on the small molar tooth having more fissures. The intervention is absolutely painless, does not hinder the correct closing of the denture, does not damage the tooth, essentially it receives an additional protection. After the careful cleaning, preparation of the tooth, the dentist fills the fissure with a liquid fissure filling material and hardens it by a polymerizing light. The procedure takes a short time, and after its completion, the tooth can be put under load immediately. Filling of teeth is the most frequent dental procedure. It may occur that such a large part of rotten tooth has to be removed that it already cannot be saved. Using so-called inserts, that is inlays or onlays the saving of the tooth will be successful and the end result will be aesthetic. The inlay or onlay inserts are such fillings, which are prepared by the dental technician after dental hole preparation and taking precision impression. The inserts may be prepared. of ceramics, gold or zirconia ceramics. The further advantage of the procedure is that the dental technician is able to model on the plaster model such areas, as well, which cannot be reached by the dentist in the mouth. For making up the alone standing tooth loss, in addition to the conventional bridges and tooth implantation there is another possibility, as well. The procedure is minimally invasive, meaning that it is accompanied with extremely low loss of tooth material. The teeth do not such a degree of grinding as in case of making a conventional bridge. The secret of the modern technology is included in the reinforcing fibers having high load bearing capacity, teeth prepared by this technology resist to the high impact occurring during chewing. The dentist prepare small holes in the teeth adjacent to the missing one, or modifies the filling probably being in them. After that, a very accurate impression is prepared, based on which the dental technician prepares the inlay bridge replacing the missing tooth or teeth with two extensions fitting in the holes prepared in the adjacent teeth. The great advantage of the procedure is that the inlay bridges close very precisely, are much more aesthetic that the conventional bridges, and even from a close distance you cannot see that they are not own teeth. The inlay bridge means an ideal solution for those people, which are looking for a solution including a less invasive, quicker and cheaper procedure than tooth implantation. There are already several procedures in the dental technics for modelling dentures. An example for that is the Hungarian patent having registration number P1400255 and title PROCEDURE AND SYSTEM OF DESIGNING AND PRODUCING IMPLANTATION MODEL, in which the preparation of an impression of the mouth shape by spoon provided with registration markers is the part of the procedure. Then after digitalization it is virtually located in the mouth of the patient and in this way it is possible to design by computer the necessary procedures. Following that, the digital model of the implantation model is prepared, which shall be prepared in reality, as well, for the realization of the procedure. Another solution is presented in the American patent “PROCESS FOR MAKING A DENTAL RESTORATION MODEL”, registration no.: US2012329008A1, which applies such a procedure where an inverse picture is made about the surface of the teeth. The preparation of the digital picture must be started up by modeling the tooth, then the surface must be inverted and in this way practically a surface being similar to a model is produced where the teeth serving the basis of sampling fit perfectly. In this way the dentures can he prepared easily. The next, also American patent “SYSTEM AND METHOD FOR VIRTUAL ARTICULATOR”, registration no.: US2004172150A1, represents a more complex solution. The patent represents such an equipment and method, which is able to follow and digitalize the movement of human jaw, and in this way, the bite movement and the positions of teeth can be easily monitored. The system analysis the movement of both lower jaw and maxillary, but separately in such a manner that the patient puts his/her head into a structure constructed for this purpose. The system is able to prepare the models during movement, then to run virtual simulations of bite and of the contacting points of teeth. In this way, it is possible to prepare analyses in order to determine where are the teeth the most vulnerable, where can be need for a probable prosthesis, reinforcement. A newer American patent titled “TOOLS FOR CUSTOMIZED DESIGN OF DENTAL RESTORATIONS”, with registration no.: US2016103935A1, describes such a procedure, during which also a 3D model is prepared about the teeth, dentures awaiting intervention. However, the solution represented in this patent is able to model not only the tooth itself, but the complete jaw and in case of prosthesis, the method of fixing of the new tooth, as well. The complete dental technical procedure can be designed by a software, in which the denture serving the basis of sampling is entered, and the final product can be fully designed with the help of a data base including standard parts.

The objective is to bring about such a digitalized three dimensional model, which is durable, and in this way the earlier state of the denture can be perfectly restored even after decades. The model prepared in this way shows to the dentist exactly how much must be taken away from the tooth in order to restore the earlier anatomic condition.

The solution is based on the recognition that the three dimensional digital model prepared about the denture is suitable for the storage of data, and in this way it can assist in case of giving advice or dental technical work, and can also provide a support to later prosthetic or surgery works.

That means, the subject of the patent is the model of the dentures and teeth, which can be prepared digitally. The present dentist and dental technical CAD/CAM systems provide the possibility for it. From the impression taken from the patient a plaster model is prepared and that is digitalized with the help of a 3-D scanner. Presently, the CAD/CAM system is used only for design and implementation. That means, the CAD is a designing basis for the processing and formulation of the later zirconium, metal, sully anatomic zirconium or temporary crown. However, in addition to the design part, the scanner function (CAD) can be used for the temporal storage of the digital anatomic conditions. In contrary to the plaster models, the digitally storage data does not deteriorate, does not get used. Its further advantage is that the digitalized format of a plaster model prepared from an even 10 years ago taken impression can be compared with the earlier model, and in this way we can see the not subjective, but objective, measurable even in microns value of changes. That is, in case the teeth of somebody wore out, or suffered an accident, loss of tooth happened, it can be easily restored to the condition existing in the earlier time of registration. It should be imagined like a backup on the computer. Taking into consideration that any problem can occur, the possibility of returning to the basis is provided. The dentists frequently meet the issue when the patient shows a 20 years old photo of his/her smile as a goal, but from that no information can be got referring to the bite, dimension or exact forms. The steps of the present technological procedure are the following: An alginate or silicon impression is made about the condition just prior to the grinding, approximately 2-3 hours before the completion of preparation. Then a silicon impression is made for the crown, inlay, other preparations for fix tooth replacement. After that the plaster model is prepared based on the impression, the bite should be also fixed, and then the plaster model is digitized. When that is ready, the following step is to design digitally the fix replacement according to the present condition reflected by the impression. Then, the digital model still must be compared with the impression of the same day in the interest of designing. The CAM system produces the zirconium full anatomic crown, the CoCr crown, the inlay, the temporary crown, frame of the zirconium crown, frame of the CoCr crown and other fix replacements. Finally, the denture is handed over in the dentist's room. after the probable technical tests.

The technical steps of the procedure represented in this patent referring to the first 4 step are completely identical with the only difference that they could happen even several years before the design of the fix replacements. In this way it provides the possibility of a better design, as it can be compared not only with the prior to grinding model of the actual day, but also with a condition existing even 20 years earlier. That means not only that an easier and more accurate design can be prepared, but it also makes possible to prepare a silicon block based on the earlier digitalized three dimensional printed model, showing to the dentist exactly, how much should be taken away from the tooth in order to ensure the restoration of the anatomic conditions, which existed at that earlier time. It can specify not only the rate of preparation, but even also the exact angle of the installation of the later implants. For that purpose, a surgical model must be prepared, to which a CBCT, a fresh impression and a 20 years earlier prepared model can provide assistance. The only reason of that this procedure still cannot be operated is that no one has a 20 years old digitalized model. Before needing a dental treatment, the digitalized models are registered. It is advisable to prepare them after the completion of the orthodontic treatments, and additionally for those patients, which for safety would like to preserve their model similarly to the stein cells and gene banks. Additionally, it also recommended to satisfied patients at the of prosthetic treatments, and there is also possibility to store the digital data for 20 years in cloud system or backup. It is possible to recall the digital data and to integrate it in the CAM system, and it is also possible to make a three dimensional print out of the digital model in order to have a real model and data about an earlier dental status e.g. at the dental technology for the creation of a ceramic cover. Actually, that is a digital data registration, no dental care service is provided, just makes possible to store data in order to provide advices, or for making possible the dental technological execution for a later prosthetic or surgery work, and in this way the discretion towards the dentist is fully maintained, no misuse can happen to the issued patient data. This is important for preserving discretion. The impression itself is taken by the cooperating dentists sending them to the user of the procedure described in the patent. The digitalization and data storage is performed after that. The storage itself is realized in a cloud system or with the help of a backup meaning, that the patient can access his/her own profile through a login menu developed on a website. Here he/she can even to request the file, may ask for a three dimensional model, which is posted to him/her or to the dentist specified by him/her. The patient's profile includes the following data and information: name, ID number, name of registering dentist, date of registration, profile picture and photos about his/her smile, photos about the impression, tooth color, photos of the digital model, the digital model itself. The person of the cooperating dentist can be selected, but the stored information is available only for the patient, and can be requested also by the patient only. The reason for that is the consideration of a probable future problem within the patient-dentist relation. In case the patient wants to change dentist, the data remain freely accessible and utilizable.

1. Procedure for the preparation of digital dental map, during which a three dimensional digital model is prepared about the human teeth and dentures, the later plaster model made on the basis of a later taken impression can be compared with the earlier sample, and in this way the not subjective, but objective, measurable even in microns changes become visible and if the teeth wore out, or after suffering an accident, loss of tooth happened, it can be easily restored to the condition existing in the earlier time of registration.

2. Procedure of preparation digital dental map according to claim 1, wherein a three dimensional printable real model can be produced from the data even by decades later, the qualitative characteristics of the stored model do not change.

3. Procedure of preparation digital dental map according to claim 1, wherein the procedure provides the possibility of the preparation of a more thorough design both in the field of prosthetics, implantology and orthodoncy, and the original face profile can be preserved for a life.

4. Procedure of preparation digital dental map according to claim 1, wherein the data storage is independent from the dentist providing the treatment.

5. Procedure of preparation digital dental map according to claim 2, wherein the procedure provides the possibility of the preparation of a more thorough design both in the field of prosthetics, implantology and orthodoncy, and the original face profile can be preserved for a life.

6. Procedure of preparation digital dental map according to claim 2, wherein the data storage is independent from the dentist providing the treatment.

7. Procedure of preparation digital dental map according to claim 3, wherein the data storage is independent from the dentist providing the treatment.

8. Procedure of preparation digital dental map according to claim 5, wherein the data storage is independent from the dentist providing the treatment.
